(19) United States
(12) Patent Application Publication
(10) Pub. No.: US 2006/0202389 A1
(43) Pub. Date: Sep. 14, 2006

(54) MAX phase glove and condom formers

(76) Inventors: Tamer El-Raghy, Voorhees, NJ (US); Michael W. Barsoum, Moorestown, NJ (US)

Correspondence Address: LICATA & TYRRELL P.C., 66 E. MAIN STREET, MARLTON, NJ, 08053, US

(21) Appl. No.: 11/435,052

(22) Filed: May 16, 2006

Related U.S. Application Data
(63) Continuation of application No. 10/666,639, filed on Sep. 19, 2003.
(60) Provisional application No. 60/478,903, filed on Jun. 13, 2003.

(51) Int. Cl. B29C 41/14

(52) U.S. Cl. 264/301; 264/305; 425/269

(57) ABSTRACT

Glove or condom formers of Mₙ₊₁AXₙ, wherein M is scandium, titanium, vanadium, chromium, zirconium, niobium, hafnium, and tantalum or a mixture thereof, A is aluminium (Al), silicon (Si), gallium (Ga), germanium (Ge), tin (Sn), lead (Pb) or indium (In) or a mixture thereof, X is carbon or nitrogen, and n is 1, 2 or 3, are provided. Methods for producing latex and synthetic polymer gloves and condoms with these formers are also provided.

This patent application is a continuation of U.S. Ser. No. 10/666,639 filed Sep. 19, 2003, which claims the benefit of priority from U.S. Provisional Application Ser. No. 60/478,903, filed Jun. 13, 2003, which is herein incorporated by reference in its entirety.

### FIELD OF THE INVENTION

The present invention relates to glove and condom formers used in the manufacture of natural latex or synthetic polymer gloves and condoms. In this invention, the glove and condom formers are comprised of a chemical resistant, durable, and thermal shock resistant material referred to herein as a MAX phase.

### BACKGROUND OF THE INVENTION

Latex and synthetic polymer examination and surgical gloves and condoms are produced using rigid molds sized and shaped to the dimensions of the finished product. Typically, such formers are comprised of materials such as ceramic, porcelain, plastic, steel and/or aluminum. The former is dipped, usually fingers first in the case of a glove former, into a bath of liquid latex or synthetic polymer and admixed chemicals so that the latex or synthetic polymer adheres to the former.

In some production methods, the glove or condom former is heated prior to dipping in the liquid latex or synthetic bath.

Further, in some production methods, the glove and condom former is pre-coated with a coagulant such as calcium nitrate which serves to gel the latex or synthetic polymer and facilitates removal of the latex or synthetic polymer glove or condom from the former.

After dipping the former in the latex or synthetic polymer bath, the latex or synthetic polymer coating on the former is allowed to dry. Additional dippings in the latex or synthetic polymer bath, followed by drying of the additional coating may be required. Further, in some production methods, the coating is further treated by leaching and/or washing to remove residual chemicals prior to removal from the former.

The glove or condom is typically released from the former by peeling the latex or synthetic polymer coating from the former, thereby inverting the glove or condom in the process. Thus, in the finished articles, the outer layer from the former is the innermost layer of the glove or condom. In some embodiments, the glove or condom is removed from the former in water.

The gloves or condoms are then packaged for shipping. In some embodiments, the gloves or condoms are sterilized prior to or in conjunction with packaging.

After repeated use involving dipping of the formers into the latex or synthetic polymer and admixed chemical baths, the ceramic, porcelain, plastic, steel or aluminum formers begin to degrade. Quality of the gloves or condoms diminishes until a replacement former is needed. For example, in accelerated aging studies with concentrated hot potassium hydroxide, a former comprised of porcelain requires replacement due to degrading after only two weeks.

Thus, there is a need for glove and condom formers comprised of more durable materials that will increase the length of use and reduce the frequency with which the formers must be replaced while maintaining the quality of the glove or condom produced.

### SUMMARY OF THE INVENTION

An object of the present invention is to provide a glove or condom former comprising a MAX phase. By “MAX phase” or “MAX phases” as used herein it is meant a material comprising Mₙ₊₁ Axₙ (n=1, 2, 3) wherein M is selected from Sc, Ti, V, Cr, Zr, Nb, Hf and Ta or a mixture thereof; wherein A is selected from Al, Si, Ga, Ge, Sn, Pb and In or a mixture thereof, and wherein X is carbon and/or nitrogen. In a preferred embodiment of the present invention, the MAX phase makes up the majority of the material used to produce the glove and condom formers.

Another object of the present invention is to provide methods for producing latex or synthetic polymer gloves and condoms which comprises dipping a glove or condom former comprising a MAX phase into a liquid latex or synthetic polymer bath so that latex or synthetic polymer coats the former; allowing the latex or synthetic polymer coating to dry on the former; and releasing the formed latex or synthetic polymer glove or condom from the former.

### DETAILED DESCRIPTION OF THE INVENTION

The present invention provides a new family of materials, referred to herein as MAX phases, for use in glove and condom formers. As demonstrated herein, MAX phases provide a chemical resistant, durable, and thermal shock resistant material for glove and condom formers.

By “MAX phase” or “MAX phases” as used herein it is meant a material comprising Mₙ₊₁ Axₙ.

M, as used in this chemical formula, is selected from scandium (Sc), titanium (Ti), vanadium (V), chromium (Cr), zirconium (Zr), niobium (Nb), hafnium (Hf), and tantalum (Ta). M may comprise a single transitional metal selected from any of Sc, Ti, V, Cr, Zr, Nb, Hf and Ta. Alternatively, M may comprise a mixture of two or more transitional metals selected from any of Sc, Ti, V, Cr, Zr, Nb, Hf and Ta.

A, as used in this chemical formula, is an element selected from aluminium (Al), silicon (Si), gallium (Ga), germanium (Ge), tin (Sn), lead (Pb) and indium (In). A may comprise a single element selected from Al, Si, Ga, Ge, Sn, Pb and In. Alternatively, A may comprise a mixture of two or more elements selected from any of Al, Si, Ga, Ge, Sn, Pb and In.

X, as used in this chemical formula, is carbon and/or nitrogen.

n, as used in this chemical formula, is 1, 2 or 3.

In a preferred embodiment of the present invention, the MAX phase makes up the majority, meaning more than 50%, of the material used to produce the glove and condom formers.

An exemplary MAX phase compound useful in the present invention is Ti₃SiC₂. Additional exemplary MAX phases which have been synthesized and found to exhibit similar characteristics are Ti₃GeC₂ and Ti₃AlC₂. MAX phases such as Ti₃SiC₂, Ti₃GeC₂, and Ti₃AlC₂ are also referred to herein as “312” compounds for the number of atoms of each element in the compound, respectively. In these MAX phases, n is equal to 2.

MAX phases may also comprise a “211” formula wherein n is equal to 1, or a “413” formula wherein n is equal to 3. An exemplary MAX phase with a 413 formula is Ti₄AlN₃. Exemplary MAX phases with a 211 formula are shown in the following Table 1.

TABLE 1
“211” COMPOUNDS

| | | | | | |
|---|---|---|---|---|---|
| Ti₂AlC | Ti2AlN | Hf₂PbC | Cr₂GaC | V₂AsC | Ti₂InN |
| Nb₂AlC | (Nb,Ti)₂AlC | Ti₂AlN_{1/2}C_{1/4} | Nb₂GaC | Nb₂AsC | Zr₂InN |
| Ti₂GeC | Cr₂AlC | Zr₂SC | Mo₂GaC | Ti₂CdC | Hf₂InN |
| Zr₂SnC | Ta₂AlC | Ti₂SC | Ta₂GaC | Sc₂InC | Hf₂SnN |
| Hf₂SnC | V₂AlC | Nb₂SC | Ti₂GaN | Ti₂InC | Ti₂TlC |
| Ti₂SnC | V₂PC | Hf₂SC | Cr₂GaN | Zr₂InC | Zr₂TlC |
| Nb₂SnC | Nb₂PC | Ti₂GaC | V₂GaN | Nb₂InC | IIf₂TlC |
| Zr₂PbC | Ti₂PbC | V₂GaC | V₂GeC | Hf₂InC | Zr₂TlN |

Carbides are generally known to be hard or brittle and not suitable for use in the manufacture of machine parts. However, synthesis of MAX phases such as titanium silicon carbide (Ti₃SiC₂) and other exemplified 312, 413 and 212 compounds described herein results in a soft, machinable, strong and lightweight material almost as machinable as graphite. Further, single-phase samples and composites of the MAX phase Ti₃SiC₂ were characterized for thermal stability and oxidation-resistance. Sample bars of Ti₃SiC₂ were quenched from 1,400° C. in water and found to have a slightly increased strength after quenching.

Accordingly, MAX phases such as Ti₃SiC₂ have properties of both metals and ceramics. Like a metal, they are machinable, thermally and electrically conductive, resistant to thermal shock, and plastic at elevated temperatures. Like a ceramic, they are refractory (i.e., have a decomposition temperature of greater than 2,000° C.), oxidation-resistant, stiff and lightweight (roughly 4.5 grams per cubic centimeter). Further, their thermal expansion is relatively low, more like a ceramic than a metal.

Various methods well known to those skilled in the art can be used for producing formers from the MAX Phases of the present invention. Exemplary methods include, but are not limited to slip casting and sintering and gel casting.

In one embodiment, a MAX phase of the present invention is slip cast and sintered into a glove or condom former by dispersing the MAX phase ceramic powder in water along with a binder and viscosity modifying agent. The dispersion preferably ranges from about 25% to 85% solids. The binder and viscosity modifier are preferably cellulose based materials. The resulting dispersion or slurry is referred to as the slip. This slip is poured into a plaster of paris mold and allowed set for at least 10 to 15 minutes, more preferably up to 60 minutes, before the excess slip is drained. Once set, the glove or condom former is removed from the mold and allowed to air dry. After drying, the former is sintered by heating in an oven at temperatures ranging from about 1300° C. to about 1600° C.

MAX phase samples of Ti3SiC2 exhibited excellent corrosion resistance in both acids and alkalis. Thus, glove and condom formers of the present invention comprising a MAX phase are expected to exhibit substantially increased durability and a phase are expected to exhibit substantially increased durability and a chemical resistance as compared to current commercially available formers.

Thus, the MAX phase glove and condom formers of the present invention are useful in the production of latex and synthetic polymer gloves and condoms. Latex and synthetic polymer gloves and/or condoms can be produced in accordance with well known procedures by dipping the glove or condom former of the present invention comprising a MAX phase into a liquid latex or synthetic polymer bath so that latex or synthetic polymer coats the former. The latex or synthetic polymer coating is then allowed to dry on the former and the resulting glove or condom is released from the former. The enhanced durability of MAX phase condom and glove formers results in a reduction in the frequency with which the formers used in this proceed must be replaced while maintaining the quality of the glove or condom produced.

It is understood that various changes and modifications to the embodiments described herein will be apparent to those skilled in the art upon reading this disclosure. Such changes and modifications can be made without departing from the spirit and scope of the present invention and its advantages over the prior art. It is, therefore, intended that such changes and modifications be included within the scope of the following claims.

What is claimed is:

1. A glove or condom former comprising Mₙ₊₁AXₙ,
wherein M is a transition metal selected from scandium, titanium, vanadium, chromium, zirconium, niobium, hafnium, and tantalum, or a mixture thereof;
wherein A is an element selected from aluminium, silicon, gallium, germanium, tin, lead and indium, or a mixture thereof;
wherein X is carbon or nitrogen; and
n is 1, 2 or 3.

2. The glove or condom former of claim 1 where M is titanium, A is selected from silicon, germanium or aluminium, X is carbon and n is 2.

3. A method for producing a latex or synthetic polymer glove or condom comprising:
(a) dipping the glove or condom former of claim 1 in a liquid latex or synthetic polymer bath;
(b) allowing the latex or synthetic polymer coating to dry on the former; and
(c) releasing the formed latex or synthetic polymer glove or condom from the former.
